(19) United States
(12) Patent Application Publication
(10) Pub. No.: US 2002/0016756 A1
(43) Pub. Date: Feb. 7, 2002

(54) Online investment banking method and apparatus

(76) Inventor: Donald P. Rinaldi, Boca Raton, FL (US)

Correspondence Address: John F. Nethery, McAndrews, Held & Malloy, Ltd., 34th Floor, 500 W. Madison Street, Chicago, IL, 60661, US

(21) Appl. No.: 09/752,858

(22) Filed: Dec. 28, 2000

Related U.S. Application Data
(60) Provisional application No. 60/175,469, filed on Jan. 11, 2000.

(51) Int. Cl. G06F 17/60

(52) U.S. Cl. 705/36; 705/42

(57) ABSTRACT

An online investment banking system includes a communication interface, a processing circuit coupled to the communication interface, and a memory coupled to the processing circuit. The memory stores investment banking service web pages and also stores instructions for execution by the processing circuit. The instructions direct the processing circuit to present a first investment banking service web page that supports a first investment banking service, monitor for an activated link to an second investment banking web service page that supports a second investment service different than the first investment service, and present the second investment banking web service page. The first and second investment banking web service pages may be selected from marketing web service pages, investor registration web pages, specific investment opportunity web pages, beta portfolio web pages, venture capital web pages, and broadcast channel web pages.

### CROSS REFERENCE TO RELATED APPLICATIONS

This application claims the benefit of Provisional Application serial No. 60/175,469, filed Jan. 11, 2000.

### BACKGROUND OF THE INVENTION

The present invention generally relates to investment banking and in particular relates to an online investment banking system providing seamless integration of traditionally independent investment banking services.

Investment banking services not only help companies and governments issue securities (e.g., through an Initial Public Offering (IPO) or Private Placement Memorandum (PPM)), but also help investors purchase securities, manage financial assets, and trade securities. Understandably, investment banking decisions are often based on a wide variety of factors with complex interactions. Furthermore, for example, during and after issuance of securities, a company typically needs effective marketing to promote their products or services. Thus, not only does a company require the services of an investment banking firm, but also the services of a marketing organization.

In the past, the complex nature of investment banking resulted in such services being offered, primarily, only by a few large firms such as Goldman Sachs and Merill Lynch. As a result, when a company such as United Parcel Service or Netscape moves forward with an IPO, the investors allowed to participate in the IPO are often limited to only those closely associated in some way with the large investment firms. It is thus well known that ordinary investors, however sophisticated, are unable to participate in most IPO opportunities.

Beyond the inaccessibility of qualified investors to important investment opportunities, past investment banking practices were limited in other respects. For example, researching a company required the investor to turn to a source of information separate from the investment banking firm. As another example, as noted above, marketing formed an investment banking service area (usually handled by dedicated marketing firms) apart from the investment banking firm itself. In other words, the complete investment banking process, in the past, was, for most inventors, inefficiently fractured into pieces and inconveniently distributed.

A need has long existed for an online investment banking system that overcomes the problems noted above and other previously experienced.

### BRIEF SUMMARY OF THE INVENTION

One aspect of the present invention is an integrated system of interlinked investment banking services web pages including marketing, investor registration, beta portfolio, venture capital, broadcast channel, and specific investment opportunity web pages. An investor may thereby move seamlessly through the investment banking process by accessing a single investment banking web site.

Another advantage of the present invention is the presentation of an investment banking investment services using multimedia files. Thus, as one example, the marketing web pages may use (possibly streaming) audio and video to effectively present marketing information.

Yet another advantage of the present invention is the ability to display the interlinked investment banking services web pages in any one of numerous languages. Thus, investors from around the world may participate in investment opportunities by accessing the investment banking system in the language they are most comfortable with.

A preferred embodiment of the present invention provides an online investment banking system. The investment banking system includes a communication interface, a processing circuit coupled to the communication interface, and a memory coupled to the processing circuit. The memory stores investment banking service web pages and also stores instructions for execution by the processing circuit. The instructions direct the processing circuit to present a first investment banking service web page that supports a first investment banking service, monitor for an activated link to an second investment banking web service page that supports a second investment service different than the first investment service, and present the second investment banking web service page.

As examples, the first and second investment banking web service pages may be selected from marketing web service pages, investor registration web pages, specific investment opportunity web pages, beta portfolio web pages, venture capital web pages, and broadcast channel web pages. After the investor has using the marketing and beta portfolio information to make an investment decision, the investment banking system may then accept an investment conditional purchase offer and responsively send a confirmation email to an investor. The investment banking system may then await a return conditional offer reaffirmation. Once a conditional offer has been reaffirmed and accepted, the investment banking system will reply to the investor with a confirmation email specifying the number of shares purchased and the issue price, as well as the location of a final prospectus.

### BRIEF DESCRIPTION OF THE DRAWINGS

FIG. 1 illustrates an online investment banking system connected through a communication network to remote terminals.

FIG. 2 shows a connection diagram between web pages.

FIG. 3 shows an example of an investor registration web page.

FIG. 4 shows an example of an online marketing web page.

FIG. 5 illustrates a new issues roadshow page.

FIG. 6 illustrates a beta portfolio web page.

FIG. 7 shows a flow diagram of the processing underlying an investment banking system.

### DETAILED DESCRIPTION OF THE INVENTION

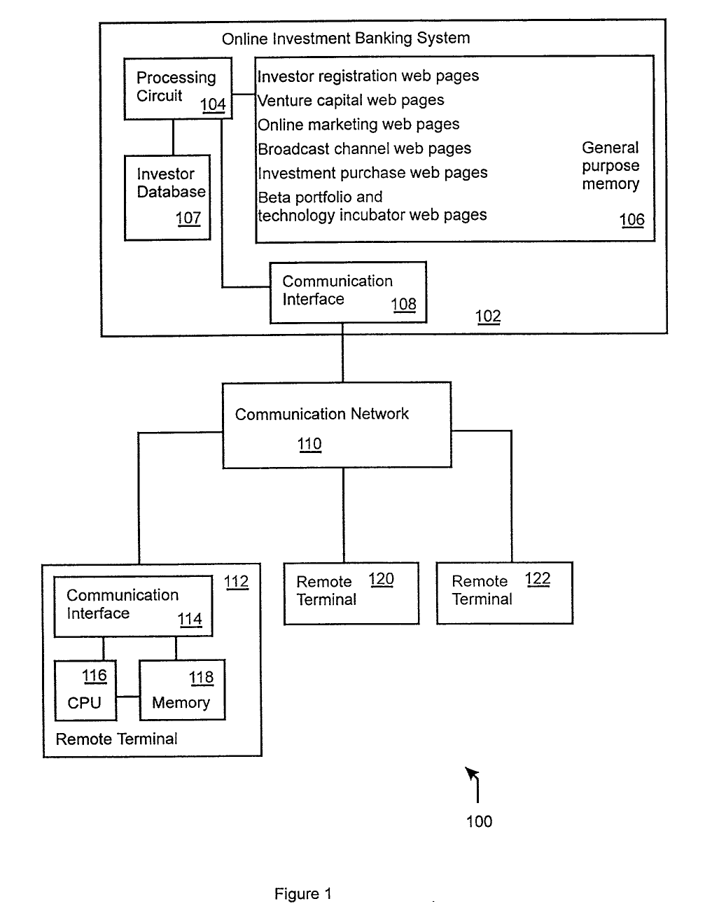

Turning to FIG. 1, that figure illustrates a network configuration 100, including an online investment banking system 102 (referred to below as the VistaWEB™ system 102). The VistaWEB™ system 102 includes a processing circuit 104 interconnected with a general purpose software memory 106, an investor database 107, and a communication interface 108. The general purpose software memory 106 is one example of a computer readable storage medium that stores instructions for execution by the processing circuit 104. The computer readable storage medium may be implemented, as examples, using a floppy disk, hard disk, magnetic tape, Read Only Memory (ROM), Random Access Memory (RAM), CDROM, or any combination of the foregoing.

FIG. 1 also illustrates a communication network 110 that connects the VistaWEB™ system 102 to a remote terminal 112. The remote terminal 112 includes a communication interface 114 interconnected with a processing circuit 116 and a general purpose memory 118. Additional remote terminals 120 and 122 are also connected through the communication network 110 to the VistaWEB™ system 102.

The communication network 110 may represent, for example, Internet routing and switching functions, or may represent proprietary LAN or WAN networks. The communication interfaces 108 and 114 may be implemented, as examples, as network interface cards or modems, and may be hardwired or wireless. The processing circuits 104 and 116 may be general purpose CPUs, such as those in the Pentium™ line of processors. As will be explained in greater detail below, the general purpose software memory 106 stores instructions for execution by the processing circuit 104. The instructions allow the processing circuit 104 to provide remote users with a complete range of investment banking services using their remote terminals 112, 120, 122.

As shown in FIG. 1, the general purpose software memory 106 also stores the web pages presented to the remote terminals 112, 120, 122. In particular, the general purpose software memory 106 stores web pages that represent investment banking services including investor registration web pages, venture capital web pages, online marketing web pages, broadcast channel web pages, specific investment opportunity web pages (e.g., web pages that allow purchase of securities in IPOs and PPMs), and beta portfolio and technology incubator web pages. The web pages include hyperlinks that provide seamless navigation between the investment banking services.

Although the web pages will be discussed in more detail below, it is initially noted that the web pages may be created with HTML and Java script that may, for example, invoke or link to Shockwave Flash™ animations, AVI, MPEG, WAV, JPEG, or any other type of multimedia audio, video, text, HTML, or image file. Furthermore, each web page is preferably provided in one or more desired languages (e.g., English, German, French, Dutch, Norwegian, Italian, Spanish, Hebrew, Finnish, Sweedish, Japanese, and Chinese) with, optionally, a language selection link on one or more of the web pages. In other words, the software memory 106 stores each of the pages described below in many different languages. The investor clicks on a language selection link to indicate to the VistaWEB™ system 102 which set of investment banking services pages to present.

Furthermore, although each of the investment banking service web pages are linked together (and thereby provide an end-to-end investment banking system), each of the web pages may also function in a stand alone fashion. As an example, the online marketing and broadcast channel web pages provide a stand alone source of marketing information for many products and services. As another example, the specific investment opportunity web pages provide independent support for investment purchases. Therefore, while an investor may in many instances use the marketing web pages to determine which investments to buy, the investor may also directly purchase an investment without first reviewing marketing information on the marketing web pages.

The remote terminals 112, 120, 122 represent personal computers connected over the Internet to the VistaWEB™ system 102. To that end, the remote terminals 112, 120, 122 execute Internet browsing software, for example, Netscape Navigator™ or Microsoft Internet Explorer™. Thus, the remote terminals 112, 120, 122 may be located anywhere in the world, and while three remote terminals 112, 120, 122 are shown, there may be thousands upon thousands of such terminals simultaneously or individually connected to the VistaWEB™ system 102 at various times. The VistaWEB™ system 102 executes complimentary Internet web server and hosting software, thereby receiving, for example, investment inquiry information from a remote terminal 112, 120, 122, and responsively presenting PPM or IPO opportunity information to the remote terminal.

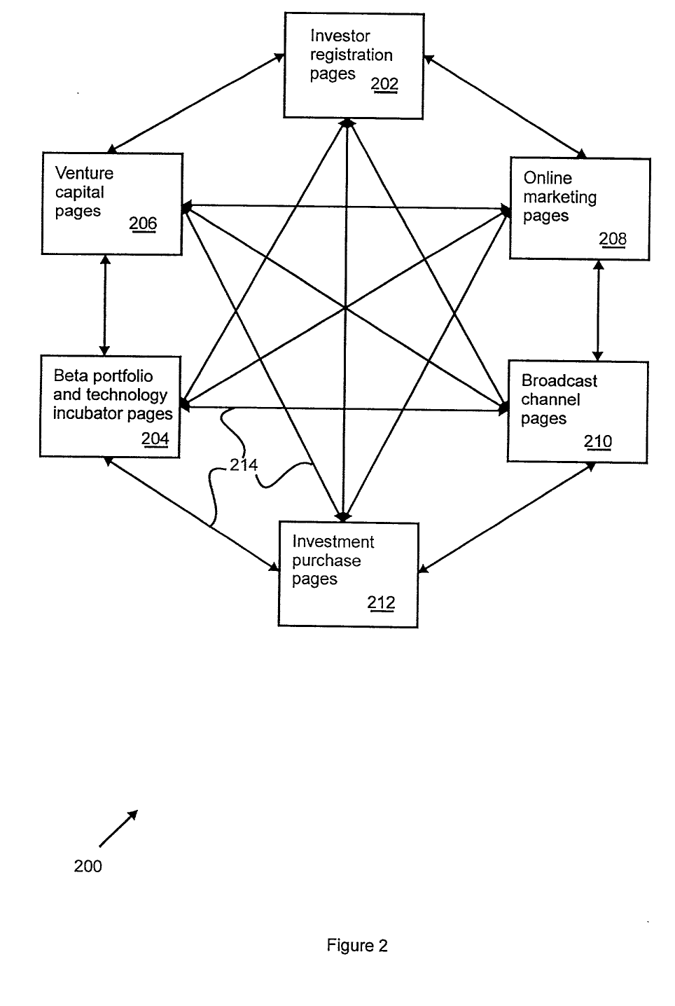

Turning now to FIG. 2, that figure shows a connection diagram 200 that includes hyperlinks between investment banking services. FIG. 2 shows, as examples of investment banking services, investor registration web pages 202, beta portfolio and technology incubator web pages 204, venture capital web pages 206, broadcast channel web pages 208, online marketing pages 210, and investment purchase web pages 212. The web pages 202-212 are linked together (using hyperlinks for example) using the links 214. In a preferred embodiment, the links 214 allow access from one investment banking service to any other investment banking service supported by the VistaWEB™ system 102 (including additional types of services not shown in FIG. 2).

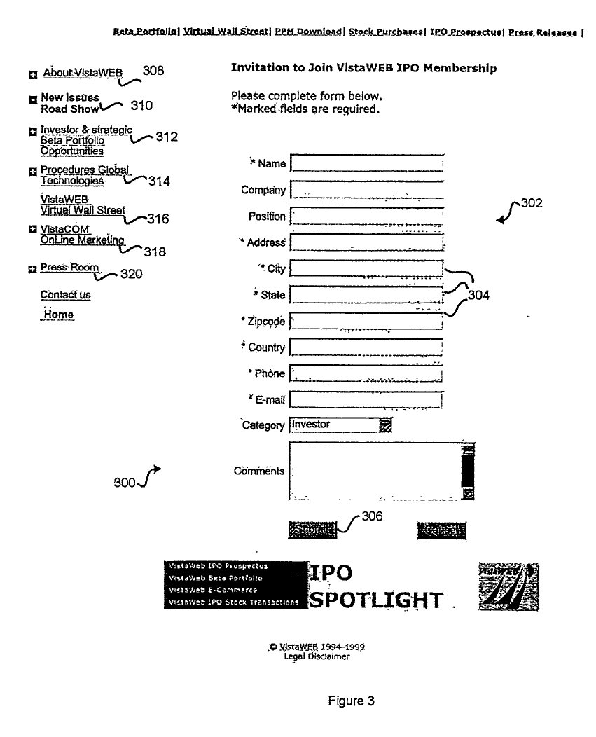

Turning next to FIG. 3, that Figure shows an example of an investor registration web page 300. The registration web page 300 includes a form 302 including investor information fields 304. A submit button 306 is provided to cause the information in the fields 304 to be submitted to the VistaWEB™ system 102. The investor registration information (e.g., name, address, email address, phone number, subsequently determined investor accreditation (e.g., Accredited, Foreign, or Sophisticated), and the like) is stored in the investor database 107.

Note also that the investor registration web page 300 includes links to other VistaWEB™ system 102 web pages for other investment banking services. For example, the information link 308 provides a link to one or more VistaWEB™ system informational web pages, the new issues link 310 provides a link to one or more specific investment opportunity web pages (on which may be provided PPM or IPO information), and a beta portfolio link 312 that provides a link to one or more beta portfolio and technology incubator web pages.

In general, each of the web pages in the VistaWEB™ system 102 will provide links to each other type of investment service web page in the VistaWEB™ system 102. Thus, an investor may move seamlessly between, marketing web pages, beta portfolio web pages, investment purchase web pages (that provide specific investment opportunity information), and the like. In other words, all of investment banking services useful to an investor are present on a single system.

Referring again to FIG. 3, also shown is a procedure link 314 that provides a link to one or more additional investment banking pages. Specifically, the procedure link 314 provides access to procedure web pages that set forth application submission requirements to the VistaWEB™ system 102 (e.g., a business plan with management credentials, technology description, marketing strategy with value points for ramp-up and commercialization, patents approved and pending, financial objectives and liquidity events to grow enterprise with revenue and margin projections, two years of financial statements, and use of proceeds), benefits of the VistaWEB™ system 102, and funding features (e.g., IPOs, secondary offerings, and PPMs, and an explanation of self-underwritten public offerings), growth capital and expansion criteria (e.g., setting forth the criteria for receiving growth expansion capital), letters of intent (e.g., explaining the VistaWEB™ system 102 procedures including, as examples, Phase I: Technology Validation; Execute Vista Growth Capital Agreement for ramp-up and commercialization; Strategic Corporate Development, Technology, Financial and Legal Advisors; Technology, Marketing and Financial Review; Corporate Recapitalization and Development of Baseline Capitalization Schedule; Establish Value Points and Liquidity Events to support Growth and Profits; Phase II: structure Liquidity Event for cash infusion and/or Corporate Strategic Alliance partner; and Phase III: Global Stock Offering Program, SB-2 Registration for Unlimited Amount or Reg A $5.0 million Initial Public Offering or Secondary Offering; Agreement Term, e.g., thirty-six months; investment of $250,000 to $1,000,000 common stock purchase warrants, voting and non-diluting, @ 10%-25% equity of outstanding shares upon recapitalization).

A virtual wall street link 316 provides a link to a download screen for the Active Worlds™ browser. The Active Worlds browser provides a 3D interactive world in which users navigate using, for example, the cursor keys on their keyboards. In particular, the 3D interactive world is designed to provide investment locations to which the user may move in order to experience investment opportunities, information, and the like in an artificial world, generally correspond, through a 3D representation, to the investment banking services offered by the VistaWEB™ system 102.

Referring still to FIG. 3, a marketing link 318 provides a link to one or more web pages of marketing presentation materials associated with investment opportunities available on the VistaWEB™ system 102. The press room link 320 provides a link to one or more web pages with news release or other publicly available information describing the VistaWEB™ system 102, or any of the companies presenting investment opportunities on the VistaWEB™ system 102.

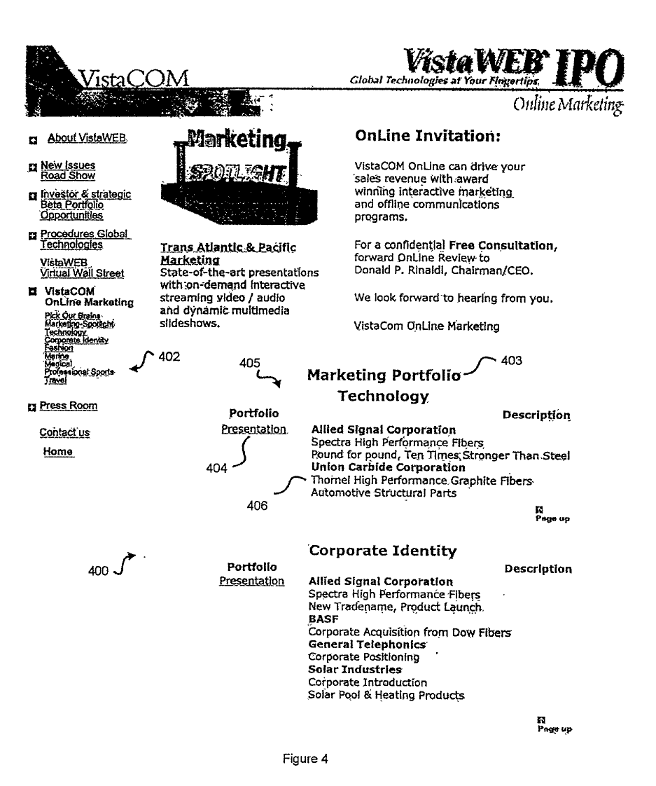

Turning next to FIG. 4, that figure shows one example of an online marketing page 400. The marketing page 400 includes subject matter links 402 to marketing information for several exemplary categories of technology (e.g., technology, corporate identity, fashion, marine, medical, professional sports, and travel). The online marketing page 400 provides links to the marketing information available for that particular technology category. As one example, the technology category 403 includes a marketing presentation link 404 and an associated marketing description 406 (e.g., Allied Signal Spectra High Performance Fibers Pound for Pound, Ten Times Stronger Than Steel). The marketing presentation link 404 provides a reference to one or more multimedia files that market the relevant technology described using, for example, a Power Point presentation, MPEG video, text file, WAV sound or combination of audio, video, and textual information. Additionally, the marketing presentation link 404 may lead to web pages which allow the investor to request (e.g., via checkboxes and a Submit button) printed information via regular mail. The marketing presentation links 404, marketing descriptions 406 are preferably presented in marketing tables 405 that use the technology category 403 as a heading.

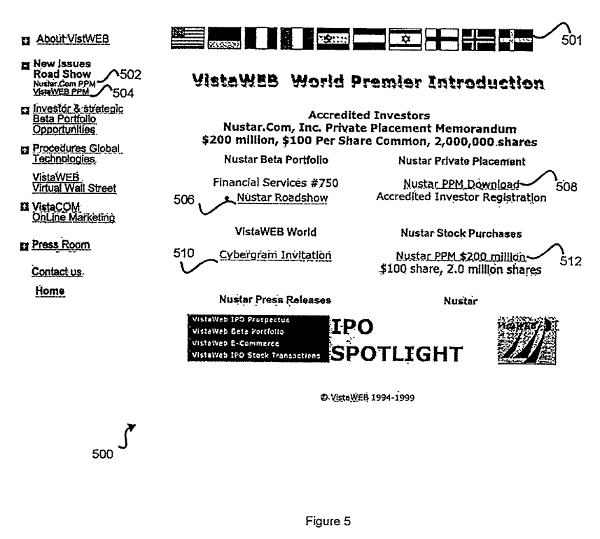

As noted above, the new issues link 310 provides a link to one or more specific investment opportunity web pages. Turning next to FIG. 5, that figure illustrates one example of a new issues roadshow page 500 that presents specific investment opportunity information, including a link to submit a conditional purchase offer. The roadshow page 500 presents investors with foreign language selection links 501 (which, when activated, cause the VistaWEB™ system 102 to present web pages in the language selected) and one or more road show links (e.g., the roadshow links 502 and 504) that provide access to specific investment opportunity information. FIG. 5 shows specific investment information and links for NuStar.com, Inc. Included is a beta portfolio link 506, a PPM download link 508, an informational link 510, and a stock purchase link 512.

The beta portfolio link 506 provides a link to an informational page that describes a beta portfolio for NuStar.com, Inc. The beta portfolio information page provides the investor with a recitation of an allocation of NuStar.com funds (e.g., 75% in growth stock, 25% in emerging high technology businesses), as well as any other desired portfolio information. The PPM download link 508 provides a link to a download page at which an investor may (through a password protection screen that requests a username and password) access the actual PPM (in this instance the PPM for NuStar.com). To this end, the VistaWEB™ system 102 may classify investors as Accredited, Foreign, or Sophisticated (pursuant to the Securities Act of 1933) before allowing access to the PPM. For this purpose, the VistaWEB™ system 102 may provide online registration forms for each type of investor, provide an investor with a login name and password, and store an investor classification associated with each investor in the investor database 107.

The informational link 510 provides a link to any desired informational page on the VistaWEB™ 102 system. In this instance, the informational link 510 provides a link to a Cybergram Invitation to join VistaWEB. With respect to the stock purchase link 512, that link provides access to a secure stock purchase page. The stock purchase page allows investors (who meet the accreditation requirements for PPMs as noted above) to place a conditional offer to purchase securities (e.g., the IPO or PPM investment opportunity offered by NuStar.com). The VistaWEB™ system 102 will confirm the conditional offer via electronic mail sent to the investor. The VistaWEB™ system 102 accepts conditional offers made “at the offering price” as determined in a final prospectus, provided the offering price is within the price range specified in a preliminary prospectus. The VistaWEB™ system 102 may also accept conditional offers made as limit orders.

The VistaWEB™ system 102 thereby provides a direct path architecture that allows an investor to focus on a single offering, with investment opportunity, marketing, and other informational services seamless integrated using links between investment banking service web pages. In other words, the investors need not turn to multiple sources of information to learn about an investment opportunity. Rather, the VistaWEB™ system 102 provides the necessary information on a single system organized under a single domain (e.g., www.VistaWEB.com) . Generally, there are no commissions, finders fees, or underwriting fees associated with use of the VistaWEB™ system 102.

The VistaWEB™ system 102 accepts conditional offers only from persons residing in jurisdictions where the investment opportunity has been registered under local securities laws or where such registration is not required. Not all offerings are registered or available in every state or country. When the Securities and Exchange Commission declares the Registration Statement effective, the VistaWEB™ system 102 notifies the investor by email. Optionally, the VistaWEB™ system 102 may wait for a response email from the investor to reaffirm the offer, and exclude investors from the offering who fail to reaffirm. Furthermore, if the offering is oversubscribed, the issuer may reject an offer or reduce the amount of securities sold pursuant to any offer. When the VistaWEB™ system 102 has reaffirmed and accepted a conditional offer, the VistaWEB™ system 102 will send the investor an email confirmation specifying the number of shares purchased and the issue price. Preferably, the VistaWEB™ system 102 sends an email message to the investor with a hyperlink or other direction to a website where the Definitive Prospectus is posted. From that site the Definitive Prospectus can be downloaded, read and printed.

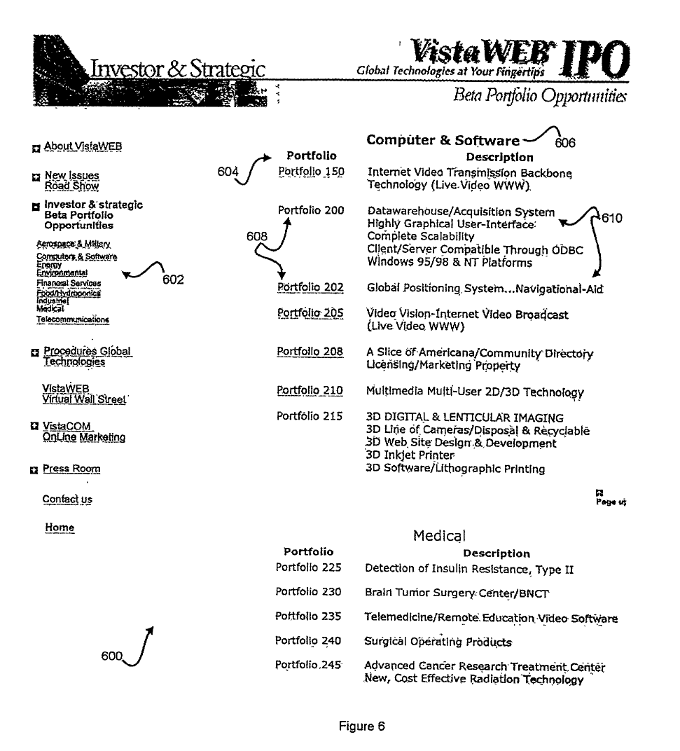

Referring again to FIG. 3, that figure includes a beta portfolio link 312 which may link to (as shown in FIG. 6) a beta portfolio web page 600. The beta portfolio web page 600 includes portfolio links 602 assigned to technology categories, as well as portfolio tables 604. As one of many possible examples, the portfolio links may be assigned to the categories of aerospace and military, computers and software, energy, environmental, financial, food/hydroponics, industrial, medical, and telecommunications. The portfolio links (when activated) position the beta portfolio web page 600 (using HTML anchors) to present the present and upcoming offerings in each particular technology category.

The offerings are preferably presented in the portfolio tables 604. In general, the portfolio tables 604 include a technology category heading 606, one or more portfolio numbers 608, and one or more portfolio descriptions 610. The portfolio numbers 608 are preferably formatted as hyperlinks to, for example, a roadshow page for the investment offering (e.g., the roadshow page 500). Alternatively, if the technology has not yet met the offering criteria (e.g., as reviewed by one or more VistaWEB analysts), then the portfolio number 608 may be formatted as a hyperlink to an informational or marketing page describing the technology. It is additionally noted that until a company meets the requirements (described above) to proceed with an investment offering, the portfolio descriptions 610 are generally kept anonymous (i.e., they do not identify the associated company) to avoid promotion of the company itself.

As noted above, the VistaWEB™ system 102 may also provide venture capital pages 206 and broadcast channel web pages 210. To that end, the venture capital web pages may provide venture capital offer submission forms (e.g., including investor identification, capital offer amount, and the like) on which registered VistaWEB™ investors offer to provide venture capital. Typically, a company defines its venture capital needs, and, on the venture capital web pages, provides a description of the required capital, and the purposes for which it is required. Furthermore, the venture capital web pages (as with any of the other investment banking service web pages) may seamlessly integrate with (by providing hyperlinks to), for example, marketing web pages that describe the company and its technology in detail. The offers to provide venture capital may come on a first come, first sever basis, or may be prioritized in another fashion by the VistaWEB™ system 102.

Additionally, the VistaWEB™ system 102 may provide broadcast channel web pages 210. The broadcast channel web pages 210 generally include multimedia playback features including streaming audio and video, as well as Java applets for scrolling text, Shockwave Flash™ animations, and the like. The broadcast channel web pages 210 therefore appear like a live news program in many respects. The information presented on the broadcast channel web pages 210 is generally related to the companies, and the companies' offerings presented on the VistaWEB™ system 102. In other words, the streaming audio and video support may provide, as examples, the latest product development information for a company, news reports for the company, reports or commentary from a moderator or industry panel of experts, university or other technology expert insight, and the like.

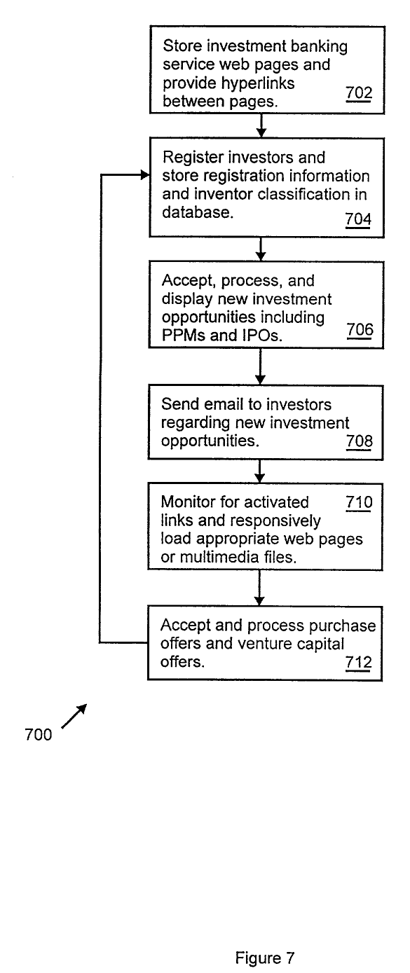

Turning now to FIG. 7, that figure illustrates a flow diagram 700 of the processing steps underlying operation of the VistaWEB™ system 102. At step 702, the VistaWEB™ system 102 initially stores the investment banking services web pages, including investor registration web pages 202, beta portfolio and technology incubator web pages 204, venture capital web pages 206, broadcast channel web pages 208, online marketing pages 210, and investment purchase web pages 212. Additionally, the web pages are provided with links to enable seamless transitions between the investment banking services (preferably as shown in FIG. 2).

Continuing at step 704, the VistaWEB™ system 102 accepts investor registration information and stores the registration information (including an investor category such as Accredited, Foreign, and Sophisticated) in the investor database 107. The VistaWEB™ system 102, at step 706, accepts (e.g., from an HTML form), stores for processing, and eventually displays online in an investment banking web page, new investment opportunities. As one example, the investment opportunities may be displayed after offline verification of the new offerings criteria discussed above with regard to FIG. 3. In conjunction with step 706, marketing presentations may, at the same time or a different time, be submitted to the VistaWEB™ system 102 to provide marketing support for the new investment opportunity. To that end, the marketing tables 705 may be updated with new links to reflect the addition of marketing information in the VistaWEB™ system 102.

Next, at step 708, the VistaWEB™ system 102 uses its investor database 107 to email investors a notification of new investment opportunities (e.g., a new IPO or PPM) available on the VistaWEB™ system 102. Note however, that the new investment opportunities are displayed on the VistaWEB™ system 102 independently of the email notifications. Thus, an investor may monitor the VistaWEB™ system 102 itself for new investment opportunities.

At step 710, the VistaWEB™ system 102 monitors for investor input, for example, mouse clicks on hyperlinks, and responsively loads the appropriate investment banking services web pages or multimedia presentations (e.g., a marketing slide show) selected. As one example, the investor may seamlessly follow a hyperlink from the beta portfolio web page 600 to the roadshow page 500. From the roadshow page 500, the investor may click on the stock purchase link 512 to enter a conditional purchase offer. As another example, the VistaWEB™ system 102 may launch a slide show in response to an investor clicking on a marketing presentation link (e.g., the presentation link 404). At step 712, the VistaWEB™ system 102 accepts and stores conditional offers or venture capital offers. The offers are processed and confirmation email is sent as noted above.

Thus, the present invention provides a fully featured online investment banking system. Unlike traditional investment banking, all of the services necessary for investors to intelligently make investment decisions are presented together in a seamless fashion on a single web site. Therefore, stockbroker middlemen may be eliminated, and virtually any accredited investor with a personal computer and Internet access may participate in significant investment opportunities (including IPOs and PPMs) without having to consult numerous independent sources of investment information. The VistaWEB™ system 102 provides links between investment banking services web pages for seamless transitions between marketing, and purchasing web pages, for example. Thus, the investor is able to quickly navigate the VistaWEB™ system 102 using single clicks to move from one major investment banking service to the next.

With reference again to the broadcast channel web pages 210, those web pages provide a VistaWEB™ Broadcast Channel, or VBC. The VBC provides both original and syndicated programming that report on the latest developments, future trends, and the like, of industries featured, for example, in the VistaWEB™ system 102 beta portfolios categories. Live and on-demand (e.g., archived news, and the like) VBC Webcasts may, for example, feature executive panel discussions between business and industry leaders, provide up-close interviews with technology developers, provide an inside look into incubator programs at top universities, and the like. Industry related VBC Broadcasts are seamlessly linked, using hyperlinks, into associated offerings in the investment opportunity web pages. Thus, the hyperlinks allow investors instant and easy access to directories, multi-media presentations, virtual roadshows, and Webcasts all without ever leaving a company's offering.

Thus, for example, a broadcast channel web page 210 may provide a schedule of weekly live webcasting events, as well as broadcast links to latest news items. When the investor clicks on a broadcast link, the VistaWEB™ system 102 responds by sending multimedia video and audio content (e.g., streaming content) to the investor's browser. Similarly, for a live webcast, the VistaWEB™ system 102 may, for example, automatically begin streaming audio and video content to the investor's browser (which may respond by opening a Windows Media Player window, or the like).

While the invention has been described with reference to a preferred embodiment, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. An investment banking system comprising:
a communication interface;
a processing circuit coupled to the communication interface; and
a memory coupled to the processing circuit, the memory storing a plurality of interlinked investment banking service web pages and storing, for execution by the processing circuit, instructions for:
presenting a first investment banking service web page that supports a first investment banking service;
monitoring for an activated link to a second investment banking web service page that supports a second investment banking service different than the first investment service; and
presenting the second investment banking web service page,
wherein the first and second investment banking web service pages are at least one of investment marketing web pages, investor registration web pages, and specific investment opportunity web pages.

2. An investment banking system according to claim 1, wherein the first and second investment banking web service pages are at least one of investment marketing web pages, investor registration web pages, specific investment opportunity web pages, beta portfolio web pages, venture capital web pages, and broadcast channel web pages.

3. An investment banking system according to claim 1, wherein the memory further comprises instructions for accepting an investment conditional purchase offer and responsively sending a confirmation email to an investor.

4. An investment banking system according to claim 1, wherein at least one investment opportunity web page includes a beta portfolio link for an investment associated with the investment opportunity web page.

5. An investment banking system according to claim 4 wherein the b eta portfolio link points to a beta portfolio information page that recites an allocation of investment opportunity funds.

6. An investment banking system according to claim 4, wherein the investment opportunity web page further includes an investment purchase link.

7. An investment banking system according to claim 4, wherein the investment opportunity web page further includes an information download link for at least one of a private placement memorandum and a initial public offering.

8. An investment banking system according to claim 1, wherein one of the first and second investment banking web service pages is a broadcast channel web page.

9. An investment banking system according to claim 8, wherein the broadcast channel web page transmits live multimedia content to a remote terminal.

10. An investment banking system according to claim 9, wherein the broadcast channel web page presents multimedia information for a predetermined set of investment categories presented on an investment marketing web page.

11. A method for online investment banking, the method comprising:
storing a plurality of interlinked investment banking service web pages in a memory;
presenting a first investment banking service web page that supports a first investment banking service;
monitoring for an activated link to a second investment banking web service page that supports a second investment banking service different than the first investment service; and
presenting the second investment banking web service page,
wherein the first and second investment banking web service pages are at least one of investment marketing web pages, investor registration web pages, and specific investment opportunity web pages.

12. The method of claim 11, wherein the first and second investment banking web service pages are at least one of investment marketing web pages, investor registration web pages, specific investment opportunity web pages, beta portfolio web pages, venture capital web pages, and broadcast channel web pages.

13. The method of claim 11, further comprising accepting an investment conditional purchase offer and responsively sending a confirmation email to an investor.

14. The method of claim 12, wherein presenting comprises presenting a broadcast channel web page and further comprising transmitting multimedia content to a remote terminal, the multimedia content associated with an investment presented on a specific investment opportunity web page.

15. The method of claim 14, wherein the multimedia content is live multimedia content.

16. The method of claim 14, wherein the multimedia content is archived multimedia content.

17. The method of claim 12, further comprising providing a language selection link allowing an investor to specify a selected language, detecting activation of the language selection link, and responsively presenting additional banking service web pages in the selected language.

18. The method of claim 12, wherein the investment marketing web pages include a include a marketing presentation link associated with a marketing description of an investment opportunity.

19. The method of claim 18, wherein investment marketing web page is organized by technology category.

20. The method of claim 18, wherein the marketing presentation link points to a multimedia presentation for the investment opportunity.
